(19) United States
(12) Patent Application Publication
(10) Pub. No.: US 2025/0243397 A1
(43) Pub. Date: Jul. 31, 2025

(54) EFFICIENT SWELLING INHIBITOR FOR DRILLING FOAMS

(71) Applicant: FIAMOCHEM INC., Toronto (CA)

(72) Inventors: Yahya DASHTI RAHMATABADI, Tehran (IR); Saeidian HAMID, Tehran (IR)

(73) Assignee: FIAMOCHEM INC., Toronto (CA)

(21) Appl. No.: 18/866,966

(22) PCT Filed: Jan. 25, 2024
(86) PCT No.: PCT/IB2024/050688

§ 371 Date: Nov. 18, 2024

(51) Int. Cl. C09K 8/38; E21B 21/14

(52) U.S. Cl. CPC C09K 8/38; E21B 21/14

(57) ABSTRACT

A formulation for producing drilling foam is developed. The formulation comprises a field-practical and environmentally friendly swelling inhibitor produced from a hydrolyzed natural protein composition, which generates synergic effect with conventional swelling inhibitors.

### TECHNICAL FIELD

The present disclosure relates to a formulation containing a hydrolyzed protein composition extracted from a plant or animal source for use in the production of drilling foam as a swelling inhibitor.

### BACKGROUND ART

Drilling is a cutting process that is used for the excavation of tunnels by tunnel boring machines (TBM), as well as exploration and production of petroleum. A typical drilling process includes activities such as rock breakage, debris removal, and maintenance of borehole stability.

During the drilling process, a fluid must convey and remove cuttings and drilled solids from the borehole, control formation pressure and maintain hole stability, seal permeable formations, cool, lubricate, and support the drilling assembly, and transmit hydraulic energy to tools and the drilling bit. Such fluid must be engineered so that it can perform efficiently in harsh environments and it must be ensured that it does not damage the formations, which are being drilled.

Oil-based and water-based fluids are two kinds of main drilling formulations. The oil-based fluids have advantages over water-based fluids in terms of shale inhibition, lubricity, and stability. However, their use has been restricted due to environmental concerns and high costs.

Water-based fluids provide excellent rheological properties with low preparation costs, and are more environmentally friendly than oil-based fluids. Foaming agents are commonly used in water-based fluids, making the operation more effective. However, water in the fluid has a strong affinity with water-sensitive shale in the wellbore formations, leading to hydration and swelling of clay particles.

There are different types of swellable clays in the tunneling process, which lead to delays in drilling operations and cost increases. During the drilling process, the interaction of swellable clay with water causes expansion and hydration, which reduces the wellbore stability and disrupts the operation.

In water-based formulations, various inhibitors are employed to prevent clay from swelling. Among these inhibitors, NaCl and KCl electrolytes are frequently utilized on a large scale to inhibit clay swelling. Nevertheless, the addition of these electrolytes can have negative consequences on the properties of drilling foam. Moreover, their excessive usage poses a significant environmental hazard due to their high consumption.

Clay swelling inhibitors have gained significant attention in recent times, with organic cationic polymers being widely utilized for this purpose. However, their low solubility and lack of compatibility with drilling fluid additives have hindered their extensive use in tunneling and drilling processes. Additionally, the high toxicity associated with cationic polymers further restricts their application in these fields.

Therefore, it is needed to develop a formulation that is environmentally friendly and cost-effective, while also being efficient in addressing the aforementioned challenges in order to produce a drilling foam with suitable rheological properties when in contact with clay formations.

### SUMMARY OF INVENTION

This summary is intended to provide an overview of the subject matter of this disclosure, and is not intended to identify essential elements or key elements of the subject matter, nor is it intended to be used to determine the scope of the claimed implementations. The proper scope of this disclosure may be ascertained from the claims set forth below given the detailed description and drawings.

In a general aspect, the present disclosure is directed to an exemplary formulation for producing a drilling foam. The exemplary formulation may comprise at least one foaming agent that may comprise a surfactant.

The above general aspect may have one or more of the following features. In an exemplary implementation, the composition may further comprise, at least one swelling inhibitor, at least one foam booster, and an electrolyte. In an exemplary implementation, the surfactant may comprise a hydrolyzed protein composition comprising of an amino acid, a peptide, a polypeptide, or a combination thereof. In an exemplary implementation, the hydrolyzed protein composition may be based on a plant protein, an animal protein, or a combination thereof. In an exemplary implementation, the plant protein may be a protein extracted from soybean, wheat, peas, or a combination thereof. In an exemplary implementation, the animal protein may be a protein extracted from the horn or hoof of an animal, blood, feather, or wool. In an exemplary implementation, the swelling inhibitor may comprise at least one electrolyte, an amino acid, a peptide, a polypeptide, or a combination thereof. In an exemplary implementation, the electrolyte may comprise potassium chloride, sodium chloride, calcium chloride, or a combination thereof. In an exemplary implementation, the amino acid may comprise glycine, lysine, methionine, alanine, arginine, proline, and a combination thereof. In an exemplary implementation, a concentration of at least one surfactant may be in the range of 15-35% by the weight of the drilling foam. In an exemplary implementation, a concentration of at least one foam booster is in a range of 2-10% by the weight of the drilling foam. In an exemplary implementation, a concentration of the hydrolyzed protein extracted from natural sources is in the range of 0.5-10% by the weight of the drilling foam. In an exemplary implementation, a concentration of the electrolyte is in the range of 0.5-10% by the weight of the drilling foam.

### BRIEF DESCRIPTION OF DRAWINGS

The provided illustration serves as a representation of one or multiple embodiments that align with the current teachings, solely for illustrative purposes and not to impose any restrictions. Hence, the drawing figure does not impose any limitations on the scope of the present disclosure. Additionally, reference numerals with corresponding numbers in the figures indicate either similar or identical elements.

FIG. 1 illustrates the percentages of a plurality of free and total amino acids in the hydrolyzed protein composition for use in the production of a drilling foam, consistent with one or more exemplary embodiments of the present disclosure.

FIG. 2 illustrates the range of molecular weights of free amino acids, peptides, and polypeptides in the hydrolyzed protein composition for use in the production of a drilling foam, consistent with one or more exemplary embodiments of the present disclosure.

FIG. 3 illustrates a zeta potential test report for an exemplary formulation, consistent with one or more exemplary embodiments of the present disclosure.

FIG. 4 Illustrates the relationship between the concentration mass (wt %) of sodium bentonite (Mt) and the yield point of the fluid when various concentrations of the hydrolyzed protein composition are present as a swelling inhibitor. This correlation aligns with the principles outlined in one or more exemplary embodiments of the present disclosure.

### DESCRIPTION OF EMBODIMENTS

In the following detailed description, numerous specific details are set forth by way of examples to provide a thorough understanding of the relevant teachings. However, it should be noted that the present teaching may be practiced without such details. In other instances, well-known processes, procedures, and components, have been described at a relatively high level, without detail, to avoid unnecessarily obscuring aspects of the present teaching. Thus, the following detailed description is not to be taken in a limiting sense, and the scope of the present disclosure is defined only by the appended claims. The present disclosure is not intended to be limited to the imple-mentations shown but is to be accorded to the widest possible scope consistent with the principles and features disclosed herein.

This disclosure provides details about a swelling inhibitor formulation that can be used in the production of drilling foam. The formulation described here offers several advantages, such as producing an environmentally friendly, non-toxic, and cost-effective drilling foam. By utilizing this exemplary formulation, the production of drilling foam can be enhanced in terms of its performance and affordability.

The formation of shale reservoirs is primarily composed of water-sensitive clay minerals, such as smectite, ilmenite, montmorillonite, and kaolin. The most abundant and naturally occurring minerals are clays. A phyllosilicate structure of two or three layers of aluminosilicate is formed in clay minerals. Each layer contains mixed sheets of octahedral Al³⁺, Mg²⁺, and Fe³⁺ oxides or tetrahedral Si⁺⁴ oxides bonded to each other and synchronized by six oxygen atoms. These minerals strongly tend to adsorb water, which results in great swelling and causes increased cohesion and sticky mud. On the other hand, the penetration of water into the walls will cause their instability and collapse.

To overcome the above-mentioned problems In an exemplary embodiment, a drilling foam formulation comprising an efficient, robust, field-practical, and environmentally friendly swelling inhibitor is developed. In an exemplary embodiment, a formulation may further comprise at least one swelling inhibitor.

The present disclosure describes an exemplary formulation of a swelling inhibitor for use in the production of drilling foam. Some benefits of utilizing the exemplary formulation for producing the drilling foam described in the present disclosure may include but are not limited to, producing an environmentally friendly, nontoxic, and af-fordable drilling foam.

In an exemplary embodiment, the hydrolyzed protein composition as a swelling inhibitor may comprise an amino acid, a peptide, a polypeptide, or a combination thereof. In an exemplary embodiment, the hydrolyzed protein composition may be based on a plant protein, an animal protein, or a combination thereof.

In an exemplary embodiment, the plant protein may be a protein extracted from soybeans, wheat, peas, or a combination thereof.

In an exemplary embodiment, the animal protein may be a protein extracted from horn and hoof, blood, feather, and wool of animals.

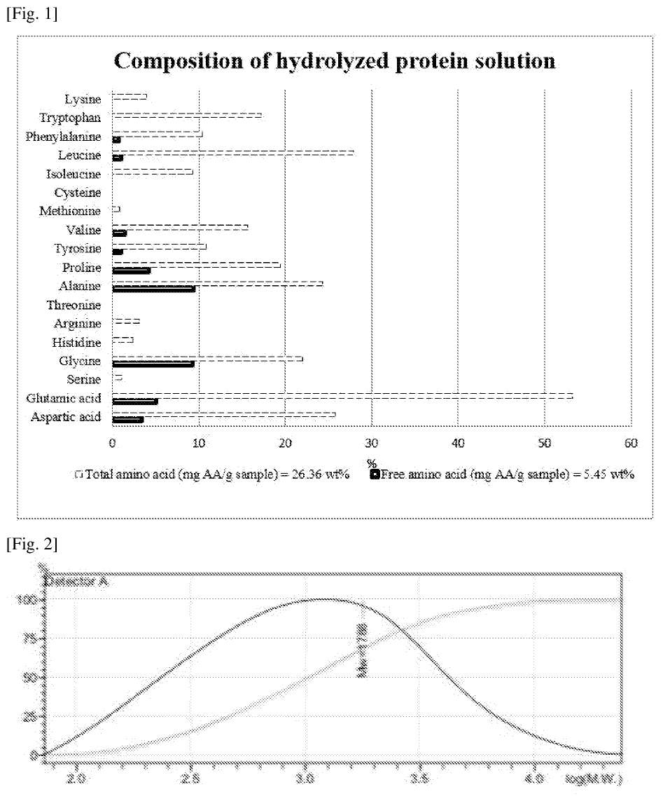

FIG. 1 illustrates a plurality of free and total amino acids existing in a hydrolyzed protein composition extracted from natural protein sources for producing drilling foam consistent with one or more exemplary embodiments of the present disclosure. In an exemplary embodiment, the hydrolyzed protein extracted from natural protein sources may comprise different kinds of amino acids, including but not limited to, aspartic acid, glutamic acid, serine, glycine, histidine, arginine, threonine, alanine, proline, tyrosine, valine, methionine, cysteine, isoleucine, leucine, phenylalanine, lysine, etc.

FIG. 2 Illustrates a variety of free amino acids, peptides, and polypeptides with specific molecular weights, as shown by one or more exemplary embodiments of the present disclosure. These amino acids, peptides, and polypeptides have a specific molecular weight falling within the range of 100-10000 Dalton. The disclosure further highlights a mechanism involving the inhibition of swelling, wherein at least one amino acid, one peptide, and/or one polypeptide interact with the clay surface, rendering it hydrophobic.

In an exemplary embodiment, at least one electrolyte may comprise, for example, but not limited to, potassium chloride, sodium chloride, calcium chloride, or a combination thereof. These electrolytes serve as a means to inhibit swelling through an osmotic mechanism. The difference in ion concentrations between the clay surface and the sur-rounding water causes water to be absorbed into the clay layers. However, the inclusion of at least one electrolyte in the foaming compositions can effectively reduce this phenomenon. In an exemplary embodiment, the concentration of hydrolyzed protein may be in the range of 0.5-10% by the weight of the drilling foam.

In an exemplary embodiment, the concentration of at least one electrolyte may be in the range of 0.5-10% by the weight of the drilling foam.

### EXAMPLES

### Example 1: Preparation of a Formulation for Producing a Drilling Foam

In Example 1, the preparation of an exemplary formulation for producing a drilling foam was carried out, consistent with one or more exemplary embodiments of the present disclosure. In this example, 0.5-10% (wt. %) of the hydrolyzed protein solution containing the plurality of amino acids, peptides, and polypeptides ([FIG. 1]), 10-35% of one or more surfactants, 2-10% of a foam booster, and 0.5-10% of an electrolyte were stirred at room temperature for 15-20 minutes.

### Example 2: Characterization

To evaluate the effect of the exemplary formulation obtained in Example 1 with rheological properties of sodium bentonite (Mt) solution, a clay mud was prepared by mixing the appropriate mass percentage of the mentioned drilling foam in Example 1, and Mt in water. Then, a rheology test was carried out by a cone-plate rotating viscometer (Lamy RM100). The apparent viscosity (AV, in centipoise, cP) and yield point (YP, in Pascal, Pa) of the mud were determined at 300 and 600-rpm dial readings according to the available formulas in the American Petroleum Institute (API) standard method for assessment of drilling fluids. AV and YP are measures as Newtonian or non-Newtonian behavior of a test sample. The lower the values of these rheological pa-rameters, the more Newtonian behavior the test sample will be.

The AV and YP values of the exemplary muds (Example 2) are presented in Table 1, which include the optimized mass percentage of surfactant and foam boosters, as well as variable mass percentages of Mt along with hydrolyzed protein solution and KCl as swelling inhibitors.

TABLE 1
The rheological properties of the exemplary
mud obtained in Example 2

| | | Hydrolyzed | | |
|---|---|---|---|---|
| Mt % | KCl % | Protein | AV (cp) | YP (pa) |
| 4 | — | — | 0 | 0 |
| | — | 2 | 0 | 0 |
| | — | 3 | 0 | 0 |
| | 2 | — | 0 | 0 |
| | 1 | 1.5 | 0 | 0 |
| 8 | — | — | 5.69 | 9.81 |
| | — | 2 | 0 | 0 |
| | — | 3 | 0 | 0 |
| | 2 | — | 0 | 0 |
| | 1 | 1.5 | 0 | 0 |
| 12 | — | — | 22.85 | 43.96 |
| | — | 2 | 0.64 | 0.10 |
| | — | 3 | 0.0 | 0.0 |
| | 2 | — | 0.0 | 0.0 |
| | 1 | 1.5 | 0.0 | 0.0 |
| 16 | — | 2 | 2.02 | 0.25 |
| | — | 3 | 1.48 | 0.0 |
| | 2 | — | 0.91 | 0.0 |
| | 1 | 1.5 | 0.31 | 0.0 |
| 20 | — | 2 | 6.62 | 3.05 |
| | — | 3 | 3.97 | 1.80 |
| | 2 | — | 1.64 | 0.68 |
| | 1 | 1.5 | 1.32 | 0.50 |
| 24 | — | 2 | 40.45 | 26.05 |
| | — | 3 | 19.46 | 6.46 |
| | 2 | — | 2.53 | 1.13 |
| | 1 | 1.5 | 2.05 | 1.03 |
| 28 | — | 3 | 34.95 | 38.60 |
| | 2 | — | 6.70 | 8.47 |
| | 1 | 1.5 | 4.02 | 1.10 |
| 32 | 2 | — | 25.85 | 28.38 |
| | 1 | 1.5 | 12.11 | 6.81 |
| 36 | 1 | 1.5 | 20.25 | 26.50 |

In conclusion, the comparison of rheological properties reveals that the exemplary mud containing swelling inhibitors such as KCl and the hydrolyzed protein have Newtonian behavior higher than the drilling fluid without swelling inhibitors.

The comparison of rheological properties shows that the exemplary mud containing 3% by weight of the hydrolyzed protein composition have rheological properties almost the same as 2% by weight of KCl.

The analysis of rheological characteristics suggests that the mud including both hydrolyzed protein composition and KCl as swelling inhibitors exhibit lower rheological properties compared to when they are used alone. Interestingly, the combination of hydrolyzed protein composition and KCl demonstrates a synergistic effect as swelling inhibitors. This synergistic effect might be due to the different inhibition mechanisms the two have. KCl functions through the osmotic mechanism, while the hydrolyzed protein composition operates via the capping mechanism.

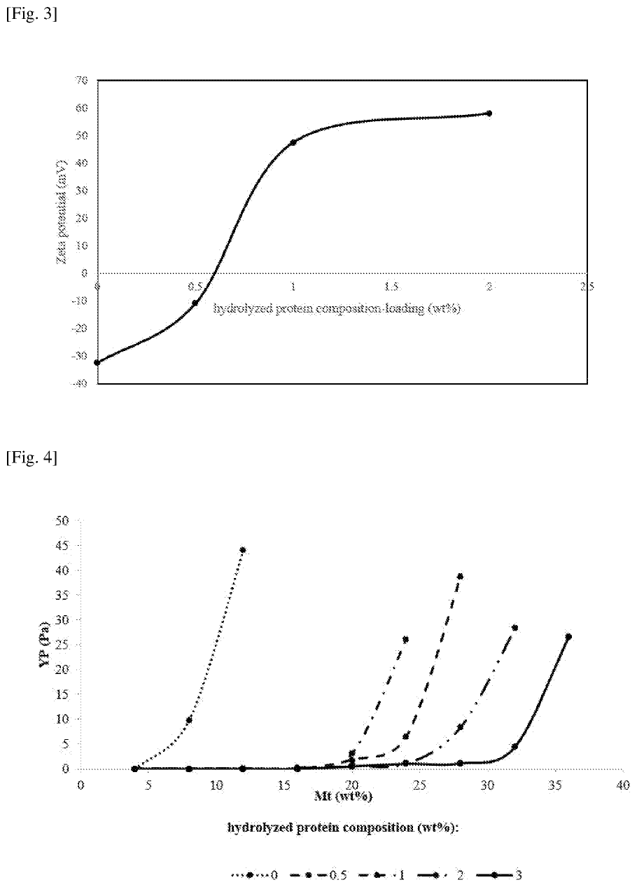

The zeta potential analysis presented in [FIG. 3] illustrates the findings of an exemplary formulation containing 12% (wt %) of Mt. Notably, an increase in the hydrolyzed protein percentage within the base mud led to a significant alteration in zeta potential. This change in charge on the clay surfaces signifies a strong interaction between the hydrolyzed protein composition and the negatively charged clay surfaces, ultimately neutralizing the positive charge on the clay surfaces. Consequently, the adsorption of water was reduced due to the adsorption of hydrolyzed protein, resulting in an enhanced inhibition of clay swelling.

The effect of different concentrations of the hydrolyzed protein composition on the YP parameter of the mud was investigated and the results including the YP versus Mt loading have been presented in [FIG. 4]. The YP parameter is a hint of the tendency of clay particles to link together and resulting a flocculate structure. The low shear rate viscosities can be reflected in YP. In pure water, Mt easily adsorbed water and swelled rapidly. The hydrolyzed protein composition has an effective performance in reducing YP of the mud ([FIG. 4]). The study aimed to examine the impact of varying concentrations of the hydrolyzed protein composition on the YP parameter of the mud. The findings, which are illustrated in [FIG. 4], demonstrate the relation between YP and Mt loading. The YP parameter serves as an indicator of the tendency of clay particles to bind together, resulting in a flocculated structure. The viscosity at low shear rates can be inferred from YP values. In the absence of any additives, Mt readily absorbs water and swells rapidly. However, the hydrolyzed protein composition proves to be effective in reducing the YP of the mud, as depicted in [FIG. 4].

While particular aspects of the present subject matter described herein have been shown and described, it will be apparent to those skilled in the art that, based upon the teachings herein, changes and modifications may be made without departing from the subject matter described herein and its broader aspects and; therefore, the appended claims are to encompass within their scope all such changes and modifications as are within the true spirit and scope of the subject matter described herein. Furthermore, it is to be understood that the invention is solely defined by the appended claims. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” to introduce claim recitations.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, and the like may be used solely to distinguish one entity or action from another without necessarily requiring or implying any actual such relationship or order between such entities or actions. The terms “comprises,” “comprising,” “include,” “including,” or any other variation thereof, are intended to cover a non-exclusive inclusion, such that a process, method, article, apparatus, or device that comprises a list of elements does not include only those elements but may include other elements not expressly listed or inherent to such process, method, article, apparatus, or device. An element proceeded by “a” or “an” does not, without further constraints, preclude the existence of additional identical elements in the process, method, article, or device that comprises the element. Moreover, “may” and other permissive terms are used herein for describing optional features of various embodiments. These terms likewise describe selectable or configurable features generally, unless the context dictates otherwise.

1. A formulation for producing a drilling foam, comprising:
at least one foaming agent comprising a surfactant.

2. The formulation of claim 1, further comprising:
at least one swelling inhibitor;
at least one foam booster; and
at least one electrolyte.

3. The formulation of claim 1, wherein the surfactant comprises a hydrolyzed protein composition, wherein the hydrolyzed protein composition comprises an amino acid, a peptide, a polypeptide, or a combination thereof.

4. The formulation of claim 1, wherein the hydrolyzed protein composition is based on a plant protein, an animal protein or a combination thereof.

5. The formulation of claim 4, wherein the plant protein is a protein extracted from soybeans, wheat, peas, or a combination thereof.

6. The formulation of claim 4, wherein the animal protein is a protein extracted from horn and hoof, blood, feather, or wool of an animal.

7. The formulation of claim 2, wherein the swelling inhibitor comprises at least one electrolyte, an amino acid, a peptide, a polypeptide, or a combination thereof.

8. The formulation of claim 7, wherein at least one electrolyte comprises potassium chloride, sodium chloride, calcium chloride, or a combination thereof.

9. The formulation of claim 7, wherein the at least one amino acid comprises glycine, lysine, methionine, alanine, arginine, proline, or a combination thereof.

10. The foaming formulation of claim 1, wherein a concentration of the surfactant is in a range of 15-35% by the weight of the drilling foam.

11. The foaming formulation of claim 2, wherein a concentration of at least one foam booster is in a range of 2-10% by the weight of drilling foam.

12. The foaming formulation of claim 2, wherein a concentration of the electrolyte is in the range of 0.5-10% by the weight of drilling foam.

13. The foaming formulation of claim 3, wherein a concentration of the hydrolyzed protein extracted from natural sources is in the range of 0.5-10% by the weight of drilling foam.
